(19) United States
(12) Patent Application Publication
(10) Pub. No.: US 2016/0122210 A1
(43) Pub. Date: May 5, 2016

(54) WATER SANITIZING SYSTEM WITH A HYDROLYSIS CELL AND OZONE GENERATOR

(71) Applicant: PARAMOUNT POOLS ESPANA, S.L., Barcelona (ES)

(72) Inventor: Calin Gheorghe Cosac Albu, Barcelona (ES)

(21) Appl. No.: 14/931,827

(22) Filed: Nov. 3, 2015

Related U.S. Application Data
(60) Provisional application No. 62/074,961, filed on Nov. 4, 2014.

(51) Int. Cl. C02F 1/467; C02F 1/78

(52) U.S. Cl. CPC C02F 1/4672; C02F 1/78; C02F 2303/04; C02F 2103/42

(57) ABSTRACT

A water treatment system can include filtration and sanitizing equipment for maintaining proper water chemistries in a pool or other water feature. The water treatment system can include an ozone generator, a hydrolysis cell that hydrolyzes water having a minimum level of conductivity, and a pH regulator. Together, the ozone generator and the hydrolysis cell generate an array of different oxidizers and sanitizing agents that have varied half-lives.

### RELATED APPLICATION

This application claims the benefit of U.S. Provisional Application No. 62/074,961, filed Nov. 4, 2014, titled “Method of Sanitizing and Maintenance of Water for Swimming Pools, Spa and Fountains with Hydrolyze Process and Ozone,” the contents of which are herein expressly incorporated by reference for all purposes.

### TECHNICAL FIELD

This disclosure relates to recreational pool, spa, and water feature sanitization systems and methods including ozone generators and hydrolysis cells.

### BACKGROUND

Swimming pools, spas, and water features are popular recreational and decorative additions to residential living and numerous commercial establishments. A basic swimming pool system includes a swimming pool, a skimmer, a circulation pump, and a filter, but frequently includes automated cleaners and automated chlorinators in newer systems. Swimming pool systems require certain water chemistries to maintain a pool clean, clear, and free of contaminants. Chlorine and bromine are the most popular chemicals used to treat and sanitize pool systems from contaminants such as bacteria, algae, and viruses. For example, chlorine is frequently added to pool systems via solid or liquid chlorine-releasing compounds. Pools treated with chlorine will generally retain some residual chlorine that is available to sanitize contaminants even when the pump is not circulating water through the pool system. However, when chlorine reacts with some nitrogen-containing contaminants, chloramines are often produced. Swimmers commonly complain about eye and skin irritation from chloramines, which is also responsible for the “chlorine smell” of some pools.

Some pool systems have added ozone (O₃) generators to reduce the dependence on chlorine or bromine and reduce the side effects of their use. Ozone is a very powerful oxidizer of contaminants because the third oxygen atom readily detaches and bonds with, or oxidizes, the contaminant. Injecting ozone into contaminated pool water, however, is not a complete sanitizing solution used on its own because of drawbacks inherent with ozone. Current systems using ozone generators require some level of chlorine or bromine to act as a residual oxidizer because ozone is so unstable and reactive that it quickly oxidizes or evaporates and little or no ozone remains in the pool system within 20-60 minutes after turning off the pool pump or ozone generator. Ozone has a half-life of only 15 minutes in water at 25° C. with a pH of 7.0 (or faster as the pH increases). Moreover, ozone often reacts so quickly that much or most of the ozone remains fairly close to the injection location (typically near the pump) and does not treat contaminants affixed to the pool. Thus, algae spores circulating through the pump and filter may be attacked by ozone, but ozone is less likely to attack algae spores clinging to the side of the pool. Accordingly, ozone generation systems are currently installed with some mechanism for adding chlorine to maintain residual chlorine to address ozone's instability and short half-life in water (bromine may also be used instead of chlorine). Pools, spas, and other water features would benefit from a treatment system addressing the deficiencies of ozone generation systems.

Applicant believes that the material incorporated above is “non-essential” in accordance with 37 CFR 1.57, because it is referred to for purposes of indicating the background of the inventions or illustrating the state of the art. However, if the Examiner believes that any of the above-incorporated material constitutes “essential material” within the meaning of 37 CFR 1.57(c)(1)-(3), applicant will amend the specification to expressly recite the essential material that is incorporated by reference as allowed by the applicable rules.

### SUMMARY

Aspects and applications of the disclosure and inventions presented here are described below with reference to the Drawings and the Detailed Description. Unless specifically noted, it is intended that the words and phrases in the specification and the claims be given their plain, ordinary, and accustomed meaning to those of ordinary skill in the applicable arts. The inventors are fully aware that they can be their own lexicographers if desired. The inventors expressly elect, as their own lexicographers, to use only the plain and ordinary meaning of terms in the specification and claims unless they clearly state otherwise and then further, expressly set forth the “special” definition of that term and explain how it differs from the plain and ordinary meaning Absent such clear statements of intent to apply a “special” definition, it is the inventors' intent and desire that the simple, plain and ordinary meaning to the terms be applied to the interpretation of the specification and claims.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

### BRIEF DESCRIPTION OF THE DRAWINGS

A more complete understanding of the present invention may be derived by referring to the detailed description when considered in connection with the following illustrative figures. In the figures, like reference numbers refer to like elements or acts throughout the figures.

FIG. 1 depicts a sanitization system.

FIG. 2 depicts a sanitization system with a pH regulator.

Elements and acts in the figures are illustrated for simplicity and have not necessarily been rendered according to any particular sequence or embodiment.

### DETAILED DESCRIPTION

In the following description, and for the purposes of explanation, numerous specific details are set forth in order to provide a thorough understanding of the various aspects of the invention. It will be understood, however, by those skilled in the relevant arts, that the present invention may be practiced without these specific details. In other instances, known structures and devices are shown or discussed more generally in order to avoid obscuring the invention. In many cases, a description of the operation is sufficient to enable one to implement the various forms of the invention, particularly when the operation is to be implemented in software. It should be noted that there are many different and alternative configurations, devices and technologies to which the disclosed inventions may be applied. The full scope of the inventions is not limited to the examples that are described below.

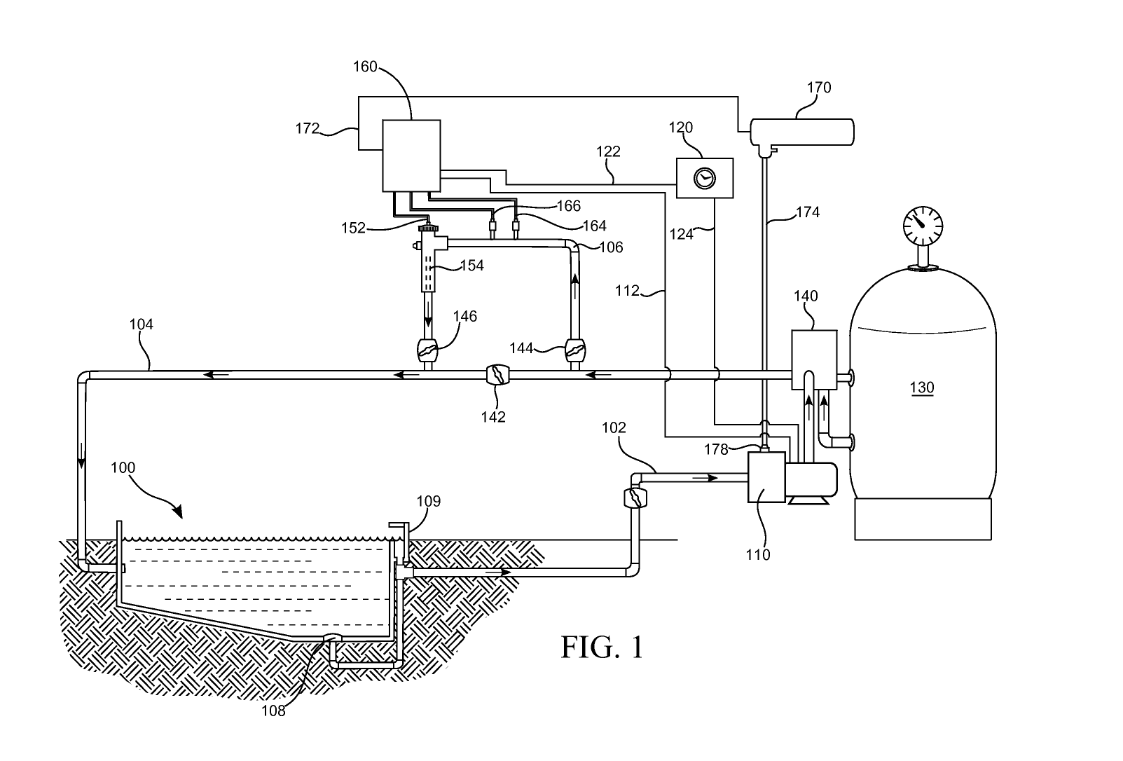

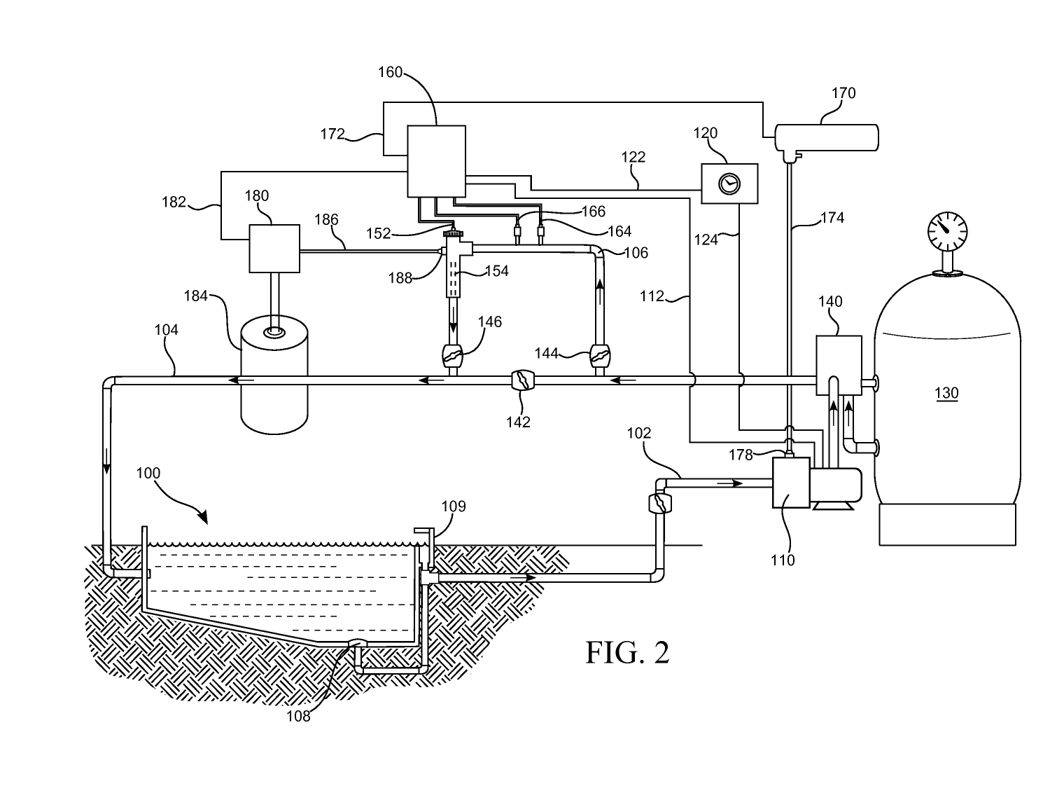

FIG. 1 illustrates a non-limiting embodiment of a water treatment system 90 and a method of treating the water by using an ozone generator in conjunction with a hydrolysis cell. References to water treatment system 90 may refer to at least one of the water treatment system 92 of FIG. 1, the water treatment system 94 of FIG. 2, alternative embodiments disclosed herein, or equivalent embodiments.

A pump 110 delivers water drawn from pool 100 (e.g., from main drain 108 and skimmer 109) via intake line 102 to filter 130, through multi-port valve 140, and then back to pool 100 via return line 104. Pool 100 may be a pool or water feature used in recreational applications including without limitation: a residential swimming pool, a commercial swimming pool, a spa or hot tub, a decorative water feature, a recreational water feature (e.g, waterslide, play fountain, waterfall, or lazy river), or similar recreational aquatic systems and applications. Pump 110 comprises a water pump coupled to a motor and is collectively referred to as pump 110. Pump 110 is turned on and off by timer 120 via pump timer line 124. Pump 110 may be a single-speed pump, multi-speed pump, or variable-speed pump. Filter 130 filters water from pool 100 and may be a diatomaceous earth “DE” filter, sand filter, cartridge filter, or other filter type. Valves 142, 144, and 146 allow the water exiting filter 130 to travel directly to pool 100 or through bypass line 106 and hydrolysis cell 150 by closing valve 142 and opening valves 144 and 146.

Treatment controller 160 controls the operation of hydrolysis cell 150 and ozone generator 170. Hydrolysis cell 150, ozone generator 170, and filter 130 operate together to sanitize circulating water from contaminants such as dirt, debris, organic matter, bacteria, algae, viruses, oils, sweat, urine, sunscreen lotion, cosmetics, and so forth. According to one embodiment, a method of treating water in pool 100 utilizes ozone generator 170 in conjunction with hydrolysis cell 150. Thus, ozone generator 170 produces powerful oxidants that have a relatively short half-life, while oxidants and sanitizers having longer half-lives are produced by hydrolysis cell 150. Methods according to various disclosed embodiments provide a sanitizing solution with powerful oxidizers and sanitizers that operate while pump 110 circulates water from pool 100, but also provide residual oxidizers and sanitizers that remain in the water after pump 110 stops.

In some embodiments, elements of the water treatment system 90 are commercially available, such as: the pump 110, timer 120, filter 130, hydrolysis cell 150, treatment controller 160, ozone generator 170, or other elements. By way of example and not limited to the following examples: pump 110 may be a model SP3400VSP Variable-Speed Pool Pump manufactured by Hayward Industries, Inc.; timer 120 may be a model P1353ME pool timer from Intermatic, Inc.; filter 130 may be a model DE6020 pool filter manufactured by Hayward Industries, Inc.; hydrolysis cell 150 may be a model RCB50 hydrolysis cell manufactured by Sugar Valley, s.1.; treatment controller 160 may be a model HD3 BE PER 41256 treatment controller manufactured by Sugar Valley, s.1.; and ozone generator 170 may be a model Clear O₃ Single or Double ozone generating system manufactured by Paramount Leisure Industries.

Treatment controller 160 may communicate with one or more of the following: hydrolysis cell 150 via line 152, ozone generator 170 via line 172, timer 120 via line 122, and pump via line 112 . Treatment controller 160 may have duplex communication with timer 120 allowing treatment controller 160 to turn the water circulation to pool 100 on and off via pump 110. Alternatively, treatment controller 160 has only simplex communication with timer 120 where it senses when timer 120 has turned pump 110 on or off. In other embodiments, timer 120 is omitted and treatment controller 160 controls one or more connected elements, such as when pump 110 is on or off. Treatment controller 160 receives input from sensors 164 and 166, which measure various attributes of water entering hydrolysis cell 150. For example, sensors 164 and/or 166 can sense oxidation level, redox level, sanitizer(s) level, pH, ozone concentration levels, salinity, conductivity, water temperature, water flow (on/off) or rate, or contaminant level. Sensors 164 and 166 assist treatment controller 160 by sensing information helpful in controlling the operation of hydrolysis cell 150 and ozone generator 170.

Ozone generator 170 generates gaseous ozone (O₃) molecules that are injected into the circulating water at pump 110 via ozone delivery line 174. The ozone delivery line 174 couples to an ozone injector 178 that injects ozone into the water at a location upstream from electrolytic plates 154 housed within the hydrolysis cell 150 (e.g., injecting at pump 110, a proximal portion of return line 104, or at bypass line 106). The ozone injector 178 may be a valve, port, or other element configured to inject fluids into a stream of water. Ozone is an unstable molecule with a short half-life in water that readily gives up one oxygen atom. Ozone is a powerful oxidizer of contaminants present in the water of pool 100 because it freely gives away an oxygen atom to other molecules. Because of ozone's short half-life in water, little ozone remains 60 minutes after shutting off ozone generator 170. While ozone is present in water, it is a far better oxidizer than chlorine or bromine, but it ceases to oxidize soon after the ozone supply stops because of ozone's short half-life.

In one embodiment, ozone generator 170 is an ultraviolet (UV) or vacuum-ultraviolet (VUV) ozone generator that employs a light source to generate ultraviolet light to convert oxygen (O₂) into ozone (O₃). In some embodiments, ozone generator 170 injects ozone at a rate of 0.5 grams per cubic meter per hour (g/m³/h) or higher. Alternatively, ozone generator 170 injects ozone at a rate of 0.3 g/m³/h or higher, 0.1 g/m³/h or higher, or 0.8 g/m³/h or higher. One embodiment injects ozone generated by ozone generator at pump 110 via delivery line 174. Other embodiments connect delivery line 174 to different locations, such as: intake line 102, near or at filter 130, return line 104, bypass line 106, or other locations. In some embodiments, ozone generator 170 comprises a corona discharge style generator (e.g., where introduction of nitrogen by-products are tolerable).

Hydrolysis cell 150 comprises an electrolytic cell with at least two electrolytic plates 154 immersed in the water flowing through bypass line 106. The electrolytic plates 154 operating as electrolytic cell electrodes are metal (e.g., made entirely of, or covered with, an inert metal such as titanium, platinum, stainless steel, iridium, or ruthenium). Hydrolysis cell 150 uses one or more pairs of electrodes (anode and cathode) to hydrolyze the water (H₂O) molecules into molecules and ions created through primary or secondary reactions. Assuming ideal faradaic efficiency, the amount of hydrogen generated by hydrolyzing water in the hydrolysis cell 150 is twice the amount of oxygen, and both are proportional to the total electrical charge conducted by the solution. In actual operation of the hydrolysis cell 150, however, competing side reactions may dominate, resulting in different molecules, cations, and anions being produced and less than ideal faradaic efficiency. Hydrolysis is a chemical reaction during which molecules of water (H₂O) are generally split into hydrogen cations (H⁺, conventionally referred to as protons) and hydroxide anions (OH⁻) in the process of a chemical mechanism. For example, hydrolysis cell 150 may break apart H₂O (water) and create hydrogen cations (H⁺), oxygen (O₂), hydroxide anions (OH⁻), hydroxyls (OH), peroxides (O₂²⁻), hydrogen peroxide (H₂O₂), and other molecules. Some of the molecules created by hydrolysis cell 150 are oxidizers that have a longer half-life than ozone. For example, hydrogen peroxide in water is a powerful oxidizer and has a half-life ranging from several hours to several days depending on the temperature, pH, salinity, contaminant level, and other factors. Thus, hydrolysis cell 150 creates sanitizing products that are more stable and have longer half-lives than the ozone produced by ozone generator 170. Used together, ozone generator 170 and hydrolysis cell 150 are able to sanitize contaminants through a variety of oxidizing and sanitizing products of varying reactivity and varying half-lives. The hydrolysis reaction within hydrolysis cell 150 creates these sanitizing products that sanitize the water of pool 100, then after the hydrolysis and sanitizing process occurs, some of the sanitizing products transform into water again. The more stable sanitizing products from this reaction, such as hydrogen peroxide, are still in the water waiting to neutralize virus and bacteria that can get inside the water.

Hydrolysis cell 150 operates in water having a minimum level of conductivity in the water. Various salts are available to add to pool 100 to increase water conductivity, with sodium chloride (NaCl) being very popular because it is inexpensive, readily available, and has low toxicity risks. Other salts or other molecules may be used to obtain a desired level of conductivity of the water (e.g., MgSO₄, KCl, and so on). Conductivity can be described, for example, in measurements of millisiemen per cm (mS/cm) or microsiemen per cm (μS/cm). The total dissolved solids (TDS) in water generally correlates to the conductivity of the water. The TDS is measured in parts-per-million (ppm) of the total dissolved solids in water. The molecules and ions accounted for in a TDS measurement often include non-salts (e.g., calcium, magnesium, non-salt organics, etc.) as well as salts. However, in swimming pools and other recreational water systems, a TDS above about 2,000 ppm is customarily achieved by adding salts like NaCl, KCl, MgSO₄, or the like. For example, tap water having a TDS of 700 ppm is used to a fill pool 100, the TDS rises to 1,200 ppm due to added chemicals or environmental conditions, and then a salt water chlorine generator is added that requires 3,300 ppm of NaCl, which results in a final TDS of 4,500 ppm (the sum of the original TDS plus the added NaCl salt).

Drinking water may have a TDS as high as 700 or even 1,000 ppm and conductivity of 0-2.0 mS/cm. Swimming pools are generally considered to be fresh water pools if they have a TDS at or below about 2,000 ppm with a conductivity of up to about 3.0 mS/cm. Agricultural use of water is typically limited to water having a TDS at or below 2,000 ppm. In swimming pools and other recreational water systems, a TDS above about 2,000 ppm is customarily achieved by adding salts like NaCl, KCl, MgSO₄, or the like.

Some pools 100 use a salt water chlorine generator having an electrolytic cell to generate chlorine from salts (such as NaCl), but these salt water chlorine generators operate different from many embodiments of hydrolysis cell 150 because, for example, they have higher salinity targets than hydrolysis cell 150. For example, a salt water chlorine generator may have a salinity target of about 3,100 to 3,500 ppm NaCl, which results in a TDS of 4,000 to 6,000 ppm and a conductivity of about 6.0 to 9.0 mS/cm. These chlorine generators in salt water pools typically turn off if the salinity drops below 2,500 ppm or 2,000 ppm of NaCl (corresponding to a conductivity of about 4.5 to 5.5 mS/cm). A low salinity level in salt water pools, using NaCl as an example, would result in insufficient production of hypochlorous acid (HClO) and sodium hypochlorite (NaClO) which are the primary sanitizing agents produced through electrolysis in a salt water chlorine generator.

In operating hydrolysis cell 150, one embodiment sets a minimum level of water conductivity for pool 100 at 2.8 millisiemen per cm (mS/cm), which roughly corresponds to about 1,200 to 1,500 ppm if NaCl is used. Alternative embodiments set a minimum level of water conductivity to operate hydrolysis cell 150 at 2.0 mS/cm, 1.7 mS/cm, 3.5 mS/cm, and so on. In some embodiments, one or more of the treatment controller 160, hydrolysis cell 150, sensors 164/166, or other electronics operate to prevent the hydrolysis cell 150 from hydrolyzing the water unless the water conductivity is above a minimum threshold (e.g., above about 1.0, 1.5, 1.7, 2.0, 2.5, 2.8, 3.0, 3.5, or 4.0 mS/cm). In some embodiments, hydrolysis cell 150 is configured to hydrolyze the water when the water conductivity is below a maximum threshold (e.g., below about 3.6, 4.0, 4.5, 4.7, 5.0, 5.2, 5.4, 5.5, 6.0, 6.5, 7.0, 8.0, or 9.0 mS/cm). In some embodiments, hydrolysis cell 150 is configured to hydrolyze the water when the water conductivity is within a certain range (e.g., about 1.7-5.5, 2-5, 3-4, 2.2-5.2, 2.2-4.6, 2.6-4.2, 2.8-3.9, or 2.9-3.8 mS/cm). A user may manually add salts (e.g., NaCl) to pool 100 or use an automated system to raise the conductivity of the water if it falls below the minimum threshold to operate hydrolysis cell 150.

In certain embodiments, the hydrolysis cell 150 operates at a salinity level below the operational range of a salt water chlorine generator (such as TurboCell 15 manufactured by Hayward Industries, Inc.). For example, the hydrolysis cell 150 may operate where the water of pool 100 has a conductivity of between about 2.9 and 3.8 mS/cm while a salt water chlorine generator has an operational range of 4.5 to as high as 9.0 mS/cm. In some embodiments, water treatment system 90 does not include a salt water chlorine generator.

Treatment controller 160 operates to coordinate and control operation of hydrolysis cell 150, ozone generator 170, and possibly pump 110 (via timer 120 or by omitting timer 120). Treatment controller 160 may operate to turn pump 110 on and off, thereby controlling the flow of water through hydrolysis cell 150 and other system components. The effectiveness of ozone from ozone generator 170 and resultant products of hydrolysis cell 150 depend on various factors, such as water temperature, pH, contaminant type and level, and so on. Treatment controller 160 determines the production levels and duration of operation for hydrolysis cell 150 and ozone generator 170 to sufficiently sanitize contaminants in the water. Treatment controller 160 may determine these production levels and duration of operation based in part or in whole on information received from sensors 164 and 166.

FIG. 2 illustrates a treatment controller 160 operating with a pH controller or regulator 180. FIG. 2 shows water treatment system 94, which is similar to the water treatment system 92 of FIG. 1 in many regards, and where similar numbers denote similar elements between FIGS. 1 and 2. Water treatment system 94 differs from water treatment system 92, for example, by adding a pH regulator 180 and its related components. According to an alternative embodiment, pH regulator 180 communicates with treatment controller 160 and injects pH materials from reservoir 184 into the water via pH injection line 186. The pH injection line 186 couples to a pH injector 188 that injects pH material into the water at a location upstream from the electrolytic plates 154 of hydrolysis cell 150 (e.g., injecting at bypass line 106 or into an entry portion of hydrolysis cell 150). The pH injector 188 may be a valve, port, or other element configured to inject fluids into a stream of water. The pH regulator 180 may be automated or manual and controls the amount of pH material injected into bypass line 106. The pH regulator 180 may be, for example, a EF 150-V C11/C11 SGV IP65 pH controller/regulator manufactured by Steiel Electronica, s.r.l. The pH material residing in reservoir 184 may be a single pH material designed to either raise or lower the pH of water in pool 100. For example, a pH material of carbon dioxide (CO₂) in reservoir 184 may be used to lower the pH of water in pool 100. Alternatively, reservoir 184 may contain multiple pH materials to allow pH regulator 180 to both raise and lower the pH of water in pool 100 with a goal of maintaining a predetermined pH (e.g., pH=7.0). Treatment controller 160 may instruct pH regulator 180 on how much pH material to inject into bypass line 106 and for how long.

In further embodiments, the components of treatment controller 160, ozone generator 170, hydrolysis cell 150, pH regulator 180, and timer 120 may be merged into one or more units. For example, a single unit may house all five components. Or, a single unit may house just the computer logic for all five components. Alternatively, two or more components may be housed in a single unit, such as: treatment controller 160 and timer 120; treatment controller 160 and ozone generator 170; treatment controller 160, ozone generator 170 and hydrolysis cell 150; treatment controller 160 and pH regulator 180; and so on.

In alternative embodiments, treatment controller 160 communicates with one or more of hydrolysis cell 150, ozone generator 170, timer 120, and the optional pH regulator 180 via wireless communication. In some embodiments, one or more of treatment controller 160, hydrolysis cell 150, ozone generator 170, timer 120, and the optional pH regulator 180 interface with a wired or wireless device (e.g., handheld device, phone, tablet, or computer) to allow further control and customization from a user.

The water treatment system 90 may be designed in light of a number of non-limiting factors, such as: the volume of water in pool 100 to be treated; the maximum desired, historical, etc., temperature of the water in pool 100; the expected or actual use of the pool 100 (e.g., the maximum number of users in pool 100, public or private pool 100, whether pool 100 is a pool, spa, or water feature, the frequency of use of pool 100, the users' age and type of activity in pool 100, and so forth); equipment working time for filter 130 or other filtering or sanitizing equipment or systems; the climate and geography around pool 100; the season or weather; the location of pool 100 (e.g., presence of trees, plants and other contaminants close to pool 100); whether pool 100 is covered or uncovered (e.g., inside or outside a building), and so forth. According to these factors, the hydrolysis process and/or the ozone generating process of the water treatment system 90 may be adjusted to meet the sanitizing requirements of pool 100. The benefits of using the disclosed water treatment system 90 and its method for sanitizing the pool 100 may include: not adding to pool 100 liquid, powder, or tablet forms of the common and aggressive disinfectants of chlorine or bromine; significant savings in fresh water by not renewing the water in pool 100 where the water is disinfected using the water treatment system 90; no toxic residual chemical products in the treated water (such as chloramines); full automatic maintenance of the water; and no pollution (the water that is sent to the sewer is not contaminated with chemical disinfectant products).

It will be understood that implementations are not limited to the specific components disclosed herein, as virtually any components consistent with the intended operation of the various implementations may be utilized. Accordingly, for example, it should be understood that, while the drawing figures accompanying text show and describe particular embodiments and implementations, components may comprise any shape, size, style, type, model, version, class, grade, measurement, concentration, material, weight, quantity, and/or the like consistent with the intended operation of a methods and/or system implementations.

The concepts disclosed herein are not limited to the specific implementations shown herein. For example, it is specifically contemplated that the components included in particular implementations may be formed of any of many different types of materials or combinations that can readily be formed into shaped objects and that are consistent with the intended operation of the implementations. For example, the components may be formed of: rubbers (synthetic and/or natural) and/or other like materials; polymers and/or other like materials; plastics, and/or other like materials; composites and/or other like materials; metals and/or other like materials; alloys and/or other like materials; and/or any combination of the foregoing.

Furthermore, embodiments may be manufactured separately and then assembled together, or any or all of the components may be manufactured simultaneously and integrally joined with one another. Manufacture of these components separately or simultaneously, as understood by those of ordinary skill in the art, may involve extrusion, pultrusion, vacuum forming, injection molding, blow molding, resin transfer molding, casting, forging, cold rolling, milling, drilling, reaming, turning, grinding, stamping, cutting, bending, welding, soldering, hardening, riveting, punching, plating, and/or the like. If any of the components are manufactured separately, they may then be coupled or removably coupled with one another in any manner, such as with adhesive, a weld, a fastener, any combination thereof, and/or the like for example, depending on, among other considerations, the particular material(s) forming the components.

In places where the description above refers to particular implementations, it should be readily apparent that a number of modifications may be made without departing from the spirit thereof and that these implementations may be applied to other implementations disclosed or undisclosed. The accompanying claims are intended to cover such modifications as would fall within the true spirit and scope of the disclosure set forth in this document. The presently disclosed implementations are, therefore, to be considered in all respects as illustrative and not restrictive, the scope of the disclosure being indicated by the appended claims rather than the foregoing description. All changes that come within the meaning of and range of equivalency of the claims are intended to be embraced therein.

I claim:

1. A water treatment system, comprising:
a hydrolysis cell configured to hydrolyze water having a conductivity above 1.0 mS/cm;
an ozone generator having an ozone injector positioned upstream from the hydrolysis cell, the ozone injector being configured to inject ozone in the water at a rate above 0.4 g/m³/h; and
a pH regulator having a pH injector positioned between the ozone injector and the hydrolysis cell, wherein the pH injector injects a pH material into the water.

2. The system of claim 1, further comprising:
a first sensor positioned upstream of the pH injector; and
a second sensor positioned downstream of the ozone injector.

3. The system of claim 2, further comprising:
a treatment controller in communication with the hydrolysis cell, the ozone generator, the pH regulator, and the first and second sensors, wherein the treatment controller is configured to cause the pH regulator to inject pH material into the water based at least on a measurement from the first sensor and the treatment controller is further configured to cause the ozone generator to inject ozone into the water based at least on a measurement from the second sensor.

4. The system of claim 3, wherein the first sensor comprises a pH sensor configured to measure the pH of the water and the second sensor comprises an ozone sensor configured to measure a concentration of ozone in the water.

5. The system of claim 3, wherein the treatment controller is configured to turn a pool pump on and off.

6. The system of claim 1, wherein the water has a conductivity between about: 1.0 and 4.4 mS/cm; 2.9 and 3.8 mS/cm; or 3.0 and 3.5 mS/cm.

7. The system of claim 1, wherein the water contains fewer than 2,000 ppm of salts selected from the group consisting of: sodium chloride (NaCl), potassium chloride (KCl), and magnesium sulfate (MgSO₄).

8. The system of claim 1, wherein the ozone generator is configured to inject ozone in the water at a rate between about 0.4 and 1.0 g/m³/h.

9. The system of claim 1, wherein the ozone injector is coupled to a pool pump.

10. A method of treating water for recreational applications, comprising:
hydrolyzing, with a hydrolysis cell, water having a conductivity between about 1.0 and 4.4 mS/cm;
generating ozone;
injecting the ozone into the water upstream of the hydrolysis cell;
measuring the pH of the water with a first sensor; and
injecting a pH material into the water upstream of the hydrolysis cell, and based at least on a measurement from the first sensor.

11. The method of claim 10, wherein the water has a conductivity between about 2.9 and 3.8 mS/cm.

12. The method of claim 10, wherein the water contains fewer than 2,000 ppm of salts selected from the group consisting of: sodium chloride (NaCl), potassium chloride (KCl), and magnesium sulfate (MgSO₄).

13. The method of claim 10, wherein injecting the ozone into the water upstream of the hydrolysis cell comprises injecting the ozone at a rate between about 0.4 and 1 g/m³/h.

14. A water treatment system, comprising:
a hydrolysis cell configured to hydrolyze water having a conductivity between about 2.0 and 4.0 mS/cm;
an ozone generator having an ozone injector positioned upstream from the hydrolysis cell, the ozone injector being configured to inject ozone in the water at a rate between about 0.4 and 1.0 g/m³/h; and
a pH regulator having a pH injector positioned between the ozone injector and the hydrolysis cell, wherein the pH injector injects a pH material into the water.

15. The system of claim 14, further comprising:
a first sensor positioned upstream of the pH injector;
a second sensor positioned downstream of the ozone injector; and
a treatment controller in communication with the hydrolysis cell, the ozone generator, the pH regulator, and the first and second sensors, wherein the treatment controller is configured to cause the pH regulator to inject pH material into the water based at least on a measurement from the first sensor and the treatment controller is further configured to cause the ozone generator to inject ozone into the water based at least on a measurement from the second sensor.

16. The system of claim 15, wherein the water has a conductivity between about: 2.9 and 3.8 mS/cm; or 3.0 and 3.5 mS/cm.

17. The system of claim 15, wherein the water contains fewer than 2,800 ppm of salts selected from the group consisting of: sodium chloride (NaCl), potassium chloride (KCl), and magnesium sulfate (MgSO₄).

18. The system of claim 17, wherein the water contains fewer than 2,000 ppm of salts selected from the group consisting of: sodium chloride (NaCl), potassium chloride (KCl), and magnesium sulfate (MgSO₄).

19. The system of claim 15, wherein the first sensor comprises a pH sensor configured to measure the pH of the water and the second sensor comprises an ozone sensor configured to measure a concentration of ozone in the water.

20. The system of claim 19, wherein the ozone injector is coupled to a pool pump.
